(19) United States
(12) Patent Application Publication
(10) Pub. No.: US 2022/0274096 A1
(43) Pub. Date: Sep. 1, 2022

(54) MOFS/MIPS CATALYST AND IN-SITU GROWTH PREPARATION METHOD THEREOF AND APPLICATION

(71) Applicant: SOUTH CHINA UNIVERSITY OF TECHNOLOGY, Guangzhou (CN)

(72) Inventors: Jinquan WAN, Guangzhou (CN); Su DING, Guangzhou (CN); Yongwen MA, Guangzhou (CN); Yan WANG, Guangzhou (CN); Zhicheng YAN, Guangzhou (CN)

(73) Assignee: SOUTH CHINA UNIVERSITY OF TECHNOLOGY, Guangzhou (CN)

(21) Appl. No.: 17/624,577

(22) PCT Filed: Oct. 25, 2019
(86) PCT No.: PCT/CN2019/113190

§ 371 Date: Jan. 4, 2022

(30) Foreign Application Priority Data
Jul. 15, 2019 (CN) 201910635674.1

(51) Int. Cl. B01J 31/16; B01J 31/06; B01J 37/03; C02F 1/72; B01J 37/08; B01J 37/06

(52) U.S. Cl. CPC B01J 31/1691; B01J 31/067; B01J 37/031; C02F 1/725; B01J 37/08; B01J 37/06; B01J 2531/0213; B01J 2531/842; C02F 2101/30

(57) ABSTRACT

An MOFs/MIPs catalyst, an in situ growth preparation method for same, and applications thereof are provided. The method comprises: uniformly mixing template molecules, a functional monomer, and a pore-foaming agent and performing a prepolymerization to produce a prepolymerization reaction product; uniformly mixing a cross-linking agent, an initiator, and the prepolymerization reaction product, heating, eluting the template molecules via a Soxhlet extraction, and drying to produce an imprinted polymer; uniformly mixing dimethylformamide, 2,5-dihydroxyterephthalic acid, ferrous chloride, water, methanol, and the imprinted polymer, heating, washing, using methanol for immersion and washing, and drying to produce the MOFs/MIPs catalyst.

### BACKGROUND

### Technical Field

The present invention belongs to the technical field of water pollution control, and in particular relates to a MOFs/MIPs catalyst and an in-situ growth preparation method and an application thereof.

### Description of Related Art

Dimethyl phthalate (DMP) is a type of common typical degradation-resistant organic pollutants in a water body which are mostly from industrial processes such as dyes, pesticides, coking, pulping and papermaking, pharmaceuticals, plastics, food processing, cosmetics production and the like, and enter surface water and underground water by way of direct discharge of domestic wastewater, output of a sewage treatment plant, sludge recycling and landfilling, agriculture and animal husbandry, aquaculture and the like. They are low in content, stable in structure, few in isomer, long in half-life period and high in toxicity, are generally of high lipophilic and hydrophobic properties, can be accumulated biologically in adipose tissues of biological organs and are amplified step by step along a food chain, and destroy the stability of the whole ecological system. Thus, DMP pollutes the environment severely, threatens human beings in the highest trophic level and even leads to endocrine disorder, reproduction and immune dysfunction in living bodies to play teratogenic, carcinogenic and mutagenic roles. There are different degrees of standard exceeding phenomena of DMP in most water bodies and soil in China, and in recent years, the type of pollutants are also detected in living organisms, human organs, blood and milk. With respect to the degradation-resistant organic pollutants DMP, they are treated generally by means of a biological method. A conventional biological method is long in treatment period and low in microbial activity. When the DMP is treated, microorganisms are easily poisoned to generate resistance genes, so that the whole biological system collapses. Furthermore, the microorganisms are selective to degradation of the pollutants and cannot degrade and mineralize DMP with relatively large molecular weights thoroughly, so that an effluent hardly meets a water quality demand. Therefore, conventional biological means is not applicable.

In a current stage, DMP is degraded by primarily adopting an advanced oxidation technology. The technology is high in speed and small in energy consumption. However, as more catalytic active sites are provided, free radicals generated by an oxidization system are too high in release rate and a lot of free radicals are generated instantaneously. As a result of heterogeneity, multi-component and low concentration of the oxidization system, the free radicals and the pollutants cannot be in contact quickly, and the lot of free radicals which are not used are quenched directly, and effective oxidization action of the free radicals on the pollutants cannot be exerted, so that the treatment cost is high and the degradation efficiency of the pollutants is low. In the advanced oxidization system, the presence time of the free radicals is relatively short. By taking sulfate free radicals (SO₄⁻.) generated by a persulfate (PS) system as an example, although the presence time thereof is remarkably prolonged compared with that of hydroxyl free radicals (.OH) in a Fenton system, the half life thereof is only 4 s. The recognition speed to the target pollutants directly affects utilization ratio of the free radicals and the degradation efficiency of the pollutants. Therefore, it is quite necessary to realize “quick recognition” based on “precise recognition”.

### SUMMARY

### Technical Problem

In order to overcome deficiencies in the prior art, an objective of the present invention is to provide a MOFs/MIPs catalyst and an in-situ growth preparation method and an application thereof.

The objective of the present invention is to solve the problem that biological and chemical treatment methods for treating degradation-resistant pollutants DMP in wastewater are low in efficiency, high in cost and the like and provide a method for preparing MOFs/MIPs by means of an in-situ growth method and degrading DMP in water by targeted oxidization thereof, so that target environmental pollutants in the wastewater can be removed efficiently and the water environment safety is guaranteed.

### Solution for the Technical Problem

The objective of the present invention is at least realized by one of the technical schemes as follows:

The present invention discloses a method for preparing MOFs/MIPs by means of an in-situ growth method and degrading DMP in water by targeted oxidization thereof. First of all, hydrophobic hemispherical molecularly imprinted polymers (MIPs) are prepared by mass polymerization, the MIPs are taken as a substrate, metal organic frameworks (MOFs) with catalytic active centers are embedded onto the surface by in-situ growth method, and the MIPs provide specific holes complementary to the template molecules in size, shape and functional group, recognize and adsorb the pollutants in a targeted manner and enrich the pollutants locally. The catalytic active sites of the MOFs activate an oxidant catalytically to generate free radicals with a strong oxidizing property to degrade the pollutants, so that the pollutants are degraded in a targeted manner. As the catalytic active sites and the specific recognition holes are uniformly distributed on the surfaces of the MIPs, a mass transfer process between the free radicals and the pollutants is shortened to a great extent, so that the degradation efficiency is improved. The hydrophobic MIPs substrate further can enhance the stability of the MOF while highly preferential adsorption and degradation of the organic pollutants are realized. In addition, the bulky catalyst further avoids the problem that a conventional water treatment catalyst is hardly recovered, and is easily applied practically.

An in-situ growth preparation method of a MOFs/MIPs catalyst provided by the present invention includes the following steps.

(1) a prepolymerization reaction: uniformly mixing template molecules, a functional monomer and a pore-foaming agent, performing uniform ultrasonic dispersion, and performing a prepolymerization reaction to obtain a prepolymerization reaction product.

(2) preparing hemispherical MIPs by a bulk polymerization method: uniformly mixing a crosslinking agent and an initiator with the prepolymerization reaction product in the step (1) to obtain a mixed solution, then performing water bath heating to conduct a polymerization reaction to obtain a reaction product (hemispherical MIPs) after water bath heating, eluting the template molecules by Soxhlet extraction, and performing drying to obtain the imprinted polymers.

(3) preparing MOFs/MIPs by in-situ growth method: uniformly mixing dimethyl formamide (N,N-dimethyl formamide, DMF), 2,5-dyhydroxy terephthalic acid, ferrous chloride, water, methanol and the imprinted polymers in the step (2), performing uniform ultrasonic dispersion, performing heating treatment and washing, then performing immersion in methanol (preferably, an analytically pure reagent, the purity of which is over 99.5%), performing centrifugation to take a precipitate, washing and drying the precipitate to obtain the MOFs/MIPs catalyst.

Further, the template molecules in the step (1) are dimethyl phthalate (DMP), the template molecules are targeted pollutants (DMP), the functional monomer is methacrylic acid (MMA), a volume ratio of the template molecules (DMP) to the functional monomer (MMA) is 2:1 to 4:1, the pore-forming agent is acetonitrile, a volume ratio of the template molecules (DMP) to the pore-forming agent is 1:120 to 1:130, a time of the prepolymerization reaction ranges from 0.5 hour to 1.5 hours, and a temperature of the prepolymerization reaction ranges from 3° C. to 5° C.

Preferably, in the step (1), a volume ratio of the template molecules (DMP) to the functional monomer (MMA) is 3:1, and a volume ratio of the template molecules (DMP) to the pore-foaming agent (acetonitrile) is 1:125.

Preferably, in the step (1), a time of the prepolymerization reaction is 1 hour and a temperature of the prepolymerization reaction is 4° C.

Preferably, the acetonitrile is the analytically pure reagent, the purity of which is 99.0% or above.

Further, the crosslinking agent in the step (2) is ethylene glycol dimethacrylate (EGDMA), a volume ratio of the crosslinking agent (EGDMA) in the step (2) to the template modulates (DMP) in the step (1) is 1:34 to 1:36, the initiator in the step (2) is azobisisobutyronitrile (ABIN), and a mass volume ratio of the initiator in the step (2) to the pore-forming agent in the step (1) is (0.05-0.15): 1 g/mL.

Preferably, a volume ratio of the crosslinking agent in the step (3) to the template molecules (DMP) is 1:35.

Preferably, a mass volume ratio of the initiator in the step (2) to the pore-forming agent in the step (1) is 0.1:1 g/mL.

Preferably, the ethylene glycol dimethacrylate and the azobisisobutyronitrile in the step (2) are analytically pure reagents, the purities of which are 98% or above.

Further, a heating temperature in the water bath in the step (2) ranges from 55° C. to 65° C., and a time in water bath heating ranges from 23 hours to 25 hours.

Further, a heating temperature in the water bath in the step (2) is 60° C., and a time in water bath heating is 24 hours.

Further, in the step (2), the reaction product after water bath heating is subjected to Soxhlet extraction by using a mixed solution of methanol and acetic acid, so that the template molecules on the reaction product after water bath heating are eluted, and specific recognition sites of the template molecules on the reaction product after water bath heating are vacated (holes complementary to the template molecules DMP in size, shape and functional group can recognize and adsorb the target pollutants in sewage in a targeted manner), where a volume ratio of methanol to acetic acid is 8:1 to 10:1.

Preferably, the methanol and acetic acid are both the analytically pure reagents, the purities of which are 99.5% or above.

Further, in the step (3), a volume ratio of 2,5-dyhydroxy terephthalic acid to dimethyl formamide (DMF) is 1:175 to 1:185 g/mL, a mass volume ratio of the ferrous chloride to dimethyl formamide (DMF) is 1:87.5 to 1:92.5 g/mL, a volume ratio of the dimethyl formamide (DMF) to water is 17:1 to 19:1, a volume ratio of the dimethyl formamide (DMF) to methanol is 17:1 to 19:1, and a mass volume ratio of the imprinted polymers to dimethyl formamide (DMF) is 1:8 to 1:9 g/mL.

Preferably, in the step (3), a mass volume ratio of the 2,5-dihydroxy terephthalic acid to DMF in dosage is 1:180 g/mL, a mass volume ratio of the ferrous chloride to DMF in dosage is 1:90 g/mL, a volume ratio of DMF to water is 18:1, and a mass ratio of DMF to methanol is 18:1. A mass volume ratio of the imprinted polymers to DMF is 1:8.5 g/mL.

Further, a temperature for heating treatment in the water bath in the step (3) ranges from 110° C. to 120° C., and a time in water bath heating ranges from 23 hours to 25 hours.

Preferably, a temperature for heating treatment in the step (3) is 115° C., and a time for heating treatment is 24 hours.

Further, in the step (3), the washing is washing with dimethyl formamide, and a time of the immersion in methanol ranges from 1 hour to 3 hours.

The present invention provides a MOFs/MIPs catalyst prepared by the above mentioned in-situ growth method.

The MOFs/MIPs catalyst provided by the present invention can be applied to degrading DMP in wastewater through targeted oxidation.

The method of applying the MOFs/MIPs catalyst provided by the present invention to degrade DMP in wastewater through targeted oxidation includes the following steps.

The MOFs/MIPs catalyst is added into to-be-treated wastewater, then full vibration is performed for a specific adsorption reaction, and after adsorptive equilibrium, an oxidizing agent is added to degrade the pollutants DMP in the advanced oxidization system in a targeted manner.

Further, an adding amount of the MOFs/MIPs catalyst is 1.2-4.8 g/L (i.e., 1.2-4.8 g of MOFs/MIPs catalyst is added into wastewater per litre).

In the preparation method provided by the present invention, MOFs are porous coordination polymers that are self-assembled by inorganic metal centers (metal ions/clusters) and organic ligands via coordination bridging action with periodical infinite network structures. The organic ligands serve as an electron donor to provide lone pair electrons, the metal ions/clusters serve as an electron acceptor to provide an empty electron orbit, coordination polyhedrons are connected as annular structure units to form holes, one group of annular structure units are then connected in a given manner as closed ducts, and then the ducts extend and are accumulated along a two-dimensional or three-dimensional direction to form an uniform and ordered reticular structure or three-dimensional structure. Controllability is a main feature of the MOFs materials, and organic ligands different in size, shape and coordination structure and the metal ions/clusters can be self-assembled, via a certain synthesis method, to obtain ordered crystals with active centers and geometric frameworks required by the catalytic reaction. Carboxyl and pyridine negative ions as mainstream coordination functional groups can be connected with different organic groups to regulate and control the geometric structures of the ducts, for example, they are connected with benzene rings and the like to realize linear and triangular expansion of the ligands, and are connected with sp³ hybridized carbon atoms to realize tetrahedron expansion. Different metal ions can regulate and control the catalytic activity of the MOFs. In addition, the functional groups (for example, —Br, —NH₂, —CHO and the like) carried by the organic ligands of the MOFs provide a good structural basis to embed the targeted groups on the surfaces thereof to realize functionality, so that the MOFs are an ideal catalyst.

According to the preparation method provided by the present invention, the used MIPs are a type of materials with directional adsorption functions. Bulk polymerization method is a method for preparing MIPs (different from the bulk polymerization in high polymer chemistry without a reaction solvent, in the molecular imprinting field, the volume of the solvent in bulk polymerization generally accounts for 50-80% of the total volume of the reaction system). As bulk polymerization has the advantages of easy control of reaction condition, simple and feasible reaction process, the synthesized MIPs are irregular in shape and are good in adsorption, selectivity and the like on the template molecules.

The present invention discloses a method for preparing MIPs by means of bulk polymerization. In the method, by taking the MIPs as a substrate, the MOFs with catalytic active centers are embedded onto the surface by the in-situ growth method, so that the mass transfer process is shortened, and the target degradation efficiency is improved. The hydrophobic MIPs substrate further can enhance the stability of the MOFs while high preferential adsorption and degradation of the organic pollutants are realized; in addition, the MOFs/MIPs catalyst prepared by the method is the bulky catalyst, which solves the problems that the conventional water treatment catalyst is hardly recovered and the like.

### Advantageous Effect of the Present Invention

### Advantageous Effect

Compared with the prior art, the present invention has the advantages and effects.

(1) In the in-situ growth preparation method provided by the present invention, the molecular imprinted polymers are prepared by the bulk polymerization method; the bulk polymerization method has the advantages of easy control of reaction condition, simple and feasible reaction process and the like; the MIPs synthesized in the method process are irregular in shape, and has good adsorbability and selectivity to the template molecules; and the prepared MIPs have special adsorptivity, so that the target pollutant molecules are recognized in a targeted manner, adsorbed and locally enriched.

(2) According to the in-situ growth preparation method provided by the present invention, the MOFs are loaded to the hemispherical MIPs surfaces, and the used MOFs are of controllability, have Lewis acidic active sites that are coordinated in an unsaturated manner, and can catalyze the oxidizing agent efficiently to generate free radicals with a strong oxidizing property; In addition, the functional groups (for example, —Br, —NH₂, —CHO and the like) carried by the organic ligands of the MOFs provide a good structural basis to embed the targeted groups on the surfaces thereof to realize functionality, so that the MOFs are an ideal catalyst.

(3) Poor stability of the MOFs limits application thereof in a water environment. The imprinted polymers are a type of hydrophobic compounds. The in-situ growth preparation method provided by the present invention can result in a hydrophobic effect of a local micro-environment of the MOFs by combining the MIPs with the MOFs, so that the stability of the MOFs is enhanced.

(4) The MOFs/MIPs catalyst provided by the present invention is hemispherical. Compared with most powdery MOFs catalysts in the current research stage, the MOFs/MIPs catalyst provided by the present invention can solve the problem that it is hard to recycle the catalyst, thereby facilitating actual application.

### BRIEF DESCRIPTION OF THE DRAWINGS

### Description of the Drawings

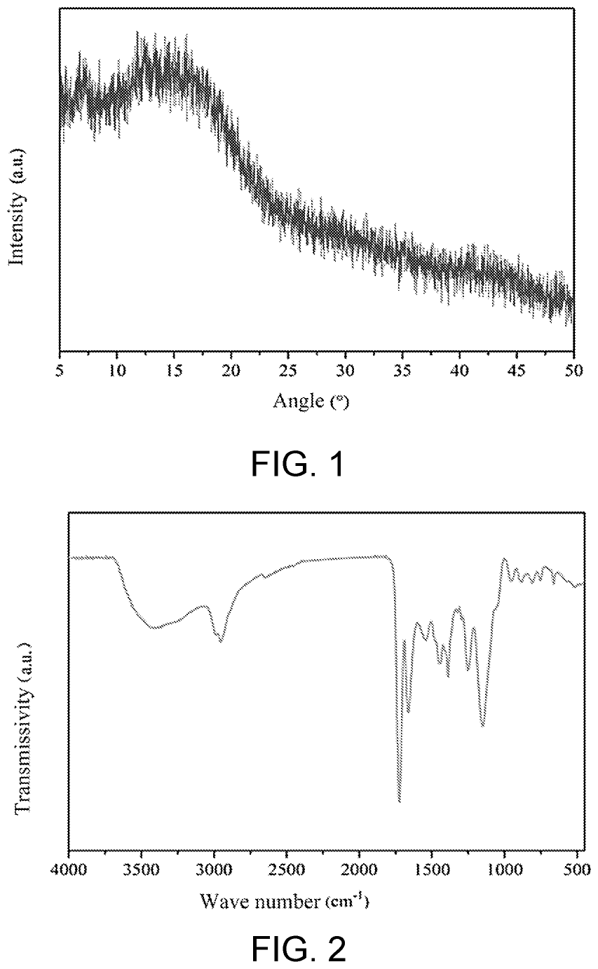

FIG. 1 is an X-ray diffraction (XRD) pattern of an MOFs/MIPs material.

FIG. 2 is a Fourier transform infrared (FTIR) pattern of an MOFs/MIPs material.

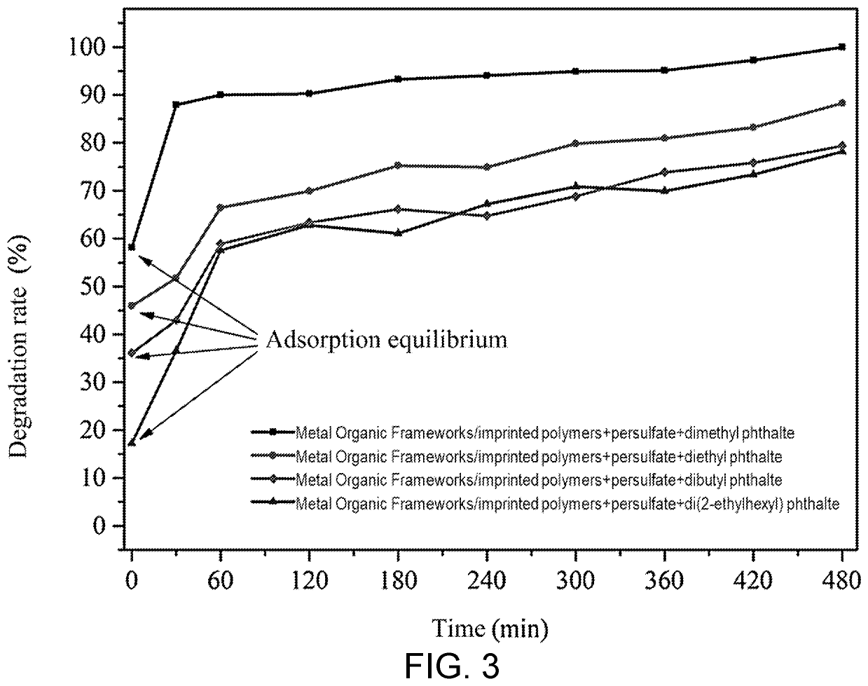

FIG. 3 is a targeted degradation curved graph of the MOFs/MIPs to DMP and structural analogues thereof.

### DESCRIPTION OF THE EMBODIMENTS

### Embodiments of the Present Invention

Further description of specific embodiments of the present invention in detail will be made below in combination with drawings and examples, but implementation and protection of the present invention are not limited thereto. It should be noted that processes that are not described in detail particularly below are realized or understood by those skilled in the field with reference to prior art. The used reagents or instruments not indicated by manufacturers are conventional products which can be purchased in the market.

### Example 1

In the embodiment, influence on effect that MIPs adsorb DMP in different reaction conditions is compared.

A method for preparing MIPs includes the following steps.

(1) Template molecules (DMP), a functional monomer (MMA) and a pore-foaming agent (acetonitrile) were added into 50 mL centrifuge tube for uniform ultrasonic dispersion and then a prepolymerization reaction was performed.

The reaction conditions were controlled in the following six types (as shown in table 1 below).

TABLE 1

| | Reaction conditions | | |
|---|---|---|---|
| | Temperature of | Time of | Volume ratio of DMP to |
| | prepolymerization | prepolymerization | MAA to acetonitrile |
| Reaction product | reaction | reaction | (DMP:MAA:acetonitrile) |
| Pre-MIPs-1 | 3° C. | 0.5 h | 2:1:120 |
| Pre-MIPs-2 | 3° C. | 1 h | 3:1:125 |
| Pre-MIPs-3 | 4° C. | 1 h | 3:1:125 |
| Pre-MIPs-4 | 4° C. | 1.5 h | 4:1:130 |
| Pre-MIPs-5 | 5° C. | 0.5 h | 2:1:120 |
| Pre-MIPs-6 | 5° C. | 1 h | 4:1:130 |

Six prepolymerization reaction products were obtained, which were respectively named as Pre-MIPs-1, Pre-MIPs-2, Pre-MIPs-3, Pre-MIPs-4, Pre-MIPs-5 and Pre-MIPs-6;

(2) Hemispherical MIPs were prepared by means of the bulk polymerization method: a crosslinking agent EGDMA and an initiator AIBN were mixed with the prepolymerization reaction product (Pre-MIPs-3 herein) uniformly in the step (1), and water bath heating was performed to carry out the polymerization reaction.

The reaction conditions were controlled in the following six types (as shown in table 2 below);

TABLE 2

| | Reaction conditions | | | |
|---|---|---|---|---|
| | Temperature of | Time of | Volume ratio | Volume ratio |
| | polymerization | polymerization | of EGDMA | of AIBN to |
| Reaction product | reaction | reaction | to DMP | acetonitrile |
| Water bath reaction | 55° C. | 23 h | 1:34 | 0.05:1 g/mL |
| product 1 | | | | |
| Water bath reaction | 60° C. | 24 h | 1:36 | 0.1:1 g/mL |
| product 2 | | | | |
| Water bath reaction | 60° C. | 24 h | 1:35 | 0.1:1 g/mL |
| product 3 | | | | |
| Water bath reaction | 65° C. | 25 h | 1:36 | 0.15:1 g/mL |
| product 4 | | | | |
| Water bath reaction | 55° C. | 23 h | 1:34 | 0.05:1 g/mL |
| product 5 | | | | |
| Water bath reaction | 65° C. | 25 h | 1:36 | 0.15:1 g/mL |
| product 6 | | | | |

The volume ratio of EGDMA to DMP in the table 2 was the volume ratio of EDGMA in the step (2) to the DMP in the step (1), and the mass volume ratio of the AIBN to the acetonitrile in the table 2 was the mass volume ratio of the AIBN in the step (2) to the acetonitrile in the step (1).

The obtained six reaction products after water bath heating (corresponding water bath reaction products 1-6 in the table 2), were subjected to Soxhlet extraction by using a mixed solution of methanol (analytical pure, 99.5%) and acetic acid (analytical pure, 99.5%) respectively. In the mixed solution, the volume ratio of methanol to acetic acid was 9:1, and the template molecules were eluted and dried respectively to obtain six imprinted polymers which were respectively named as MIPs-1, MIPs-2, MIPs-3, MIPs-4, MIPs-5 and MIPs-6.

(3) 30 mg/L of a DMP solution was prepared as simulated wastewater containing DMP for later use.

(4) 100 mL 30 mg/L DMP solutions were added into 6 reactors respectively by taking conical flasks as the reactors, then the MIPs-1, MIPs-2, MIPs-3, MIPs-4, MIPs-5 and MIPs-6 were respectively added, the six conical flasks were respectively placed in a table at a rotating speed of 180 rpm, an adsorption reaction was performed at a constant temperature (25° C.), and sampling and analyzing were performed in 24 hours.

The adsorbing capacities of DMP under different MIPs are as shown in Table 3 below.

TABLE 3

| MIP | MIPs-1 | MIPs-2 | MIPs-3 | MIPs-4 | MIPs-5 | MIPs-6 |
|---|---|---|---|---|---|---|
| Adsorbing | 7.3 | 10.4 | 11.3 | 8.1 | 7.9 | 10.1 |
| capacity | | | | | | |
| (mg/g) | | | | | | |

It can be known from the table 3 that in different reaction conditions, the effects that the MIPs adsorb DMP are different, and with different reaction temperatures, reaction times and different inputting proportions of the reactants in the preparation process, the adsorbing capacities of DMP change obviously. It can be known from the above table that when the prepolymerization reaction condition is as follows: the temperature is 4° C., the time is 1 hour and the volume ratio of DMP to MMA to acetonitrile is 3:1:125, the effect that the prepared MIPs (MIPs-3) absorb DMP in the simulated wastewater is optimum under the condition that the polymerization reaction condition is as follows: the temperature is 60° C., the time is 24 hours, the volume ratio of EGDMA to DMP is 1:35 and the mass volume ratio of AIBN to acetonitrile is 0.1:1 g/mL.

### Example 2

In the embodiment, influence on effect that MOFs/MIPs degrade DMP in a targeted manner in different reaction conditions is compared.

An in-situ growth preparation method of a MOFs/MIPs catalyst includes the following steps.

(1) MOFs/MIPs and MOFs/NIPs were prepared by means of in-situ growth method: DMF, 2,5-dihydroxyl terephthalic acid, ferrous chloride, water and methanol (analytical pure, 99.5%) were uniformly mixed with the imprinted polymer (MIPs-3 herein) prepared in the step (4) in Example 1 in a reaction kettle to obtain a mixed solution, ultrasonic dispersion was performed on the mixed solution, and heating treatment was performed in an oven.

The reaction conditions were controlled in the following six types (as shown in table 4 below);

TABLE 4

| | Reaction conditions | | | | | |
|---|---|---|---|---|---|---|
| | | | Mass | Mass | | |
| | | | volume | volume | | Mass |
| | | | ratio | ratio | Volume ratio | volume |
| | Temperature | Time of | (g/mL) of | (g/mL) of | of DMF to | ratio |
| | of heating | heating | 2,5-dihydroxyl | ferrous | water to | (g/mL) of |
| Reaction | treatment | treatment | terephthalic | chloride | methanol | MIPs |
| product | (° C.) | (h) | acid to DMF | to DMF | (DMF:water:methanol) | to DMF |
| Heating | 110 | 23 | 1:175 | 1:92.5 | 17:1:1 | 1:8 |
| product-1 | | | | | | |
| Heating | 115 | 24 | 1:180 | 1:87.5 | 18:1:1 | 1:8.5 |
| product-2 | | | | | | |
| Heating | 110 | 24 | 1:180 | 1:87.5 | 18:1:1 | 1:8.5 |
| product-3 | | | | | | |
| Heating | 115 | 25 | 1:185 | 1:87.5 | 18:1:1 | 1:9 |
| product-4 | | | | | | |
| Heating | 110 | 23 | 1:180 | 1:92.5 | 18:1:1 | 1:8 |
| product-5 | | | | | | |
| Heating | 120 | 25 | 1:185 | 1:87.5 | 19:1:1 | 1:9 |
| product-6 | | | | | | |

The obtained products (the heating product-1, the heating product-2, the heating product-3, the heating product-4, the heating product-5 and the heating product-6) were washed with DMF respectively and then immersed in methanol (analytical pure, 99.5%) respectively for 2 hours, centrifugation was performed respectively to take precipitates, and the precipitates were dried to obtain six reaction products (i.e., the MOFs/MIPs catalyst), and the six reaction products were respectively named as MOFs/MIPs-1, MOFs/MIPs-2, MOFs/MIPs-3, MOFs/MIPs-4, MOFs/MIPs-5 and MOFs/MIPs-6.

(2) A DMP solution (simulating wastewater containing DMP) with concentration of 30 mg/L was prepared for later use.

(3) 100 mL of DMP solutions with concentration of 30 mg/L and the MOFs/MIPs-1, MOFs/MIPs-2, MOFs/MIPs-3, MOFs/MIPs-4, MOFs/MIPs-5 and MOFs/MIPs-6 obtained in the step (2) were respectively added into the six reactors by taking conical flasks as the reactors, the six conical flasks were respectively placed in a table at a rotating speed of 180 rpm, an adsorption reaction was performed at a constant temperature (25° C.), in 24 hours (it was ensured that adsorption equilibrium was reached), the oxidizing agent PS (persulfate) was respectively added with the adding amount of 2.4 g/L, and sampling and analyzing at fixed points were performed.

The removal rates of DMP under different MOFs/MIPs catalysts are as shown in Table 5 below.

TABLE 5

| | Removal rate (%) | | | | | |
|---|---|---|---|---|---|---|
| Time | MOFs/ | MOFs/ | MOFs/ | MOFs/ | MOFs/ | MOFs/ |
| (min) | MIPs-1 | MIPs-2 | MIPs-3 | MIPs-4 | MIPs-5 | MIPs-6 |
| 0 | 48.1 | 58.1 | 55.7 | 57.3 | 52.6 | 49.1 |
| 30 | 79.1 | 87.5 | 82.8 | 83.1 | 84.9 | 77.8 |
| 60 | 80.6 | 89.3 | 83.9 | 83.9 | 85.7 | 79.7 |
| 120 | 82.3 | 90.2 | 84.2 | 84.2 | 86.4 | 81.3 |
| 180 | 83.4 | 93.5 | 84.6 | 86.4 | 87.3 | 81.7 |
| 240 | 84 | 94.7 | 85.4 | 87.3 | 88 | 81.8 |
| 300 | 84.9 | 94 | 86.9 | 89.8 | 88.8 | 82.9 |
| 360 | 85.6 | 95.2 | 88.3 | 91.5 | 90.1 | 83.5 |
| 420 | 87.9 | 97.7 | 90.6 | 93.3 | 94.2 | 85.6 |
| 480 | 89.7 | 100 | 91.1 | 98.2 | 99.6 | 87.3 |

The removal rate when the time is 0 is the removal rate when the MOFs/MIPs adsorb DMP to reach adsorption equilibrium.

It can be known from table 5 that in different reaction conditions, the effects that the MOFs/MIPs catalysts remove DMP are different, and the removal rate of DMP changes obviously with different reaction times and proportions of inputting the reactants in the preparation process; when the reaction condition in the in-situ growth preparation method is as follows: the temperature is 115° C., the time is 24 hours, the mass volume ratio of 2,5-dihydroxyl terephthalic acid to DMF is 1:180 g/mL, the mass volume ratio of ferrous chloride to DMF is 1:87.5 g/mL, the volume ratio of DMF to water to methanol is 18:1:1, and the mass volume ratio of MIPs to DMF is 1:8 g/mL, and the effects of the prepared MOFs/MIPs (the XRD patterns and the FTIR patterns of MOFs/MIPs-2 are shown in FIG. 1 and FIG. 2) that remove DMP in the simulated wastewater are optimum.

### Example 3

Targeted selectivity to DMP by the MOFs/MIPs catalyst is compared in the embodiment.

Analogues of three structures of DMP, which a diethyl phthalate (DEP) solution, a dibutyl phthalate (DBP) solution and di(2-ethylhexyl)phthalate (DEHP), were selected to perform targeted selectivity researches of the MOFs/MIPs catalysts to DMP, respectively. The DMP solution, the DEP solution, the DBP solution and the DEHP solution with initial concentrations of 30 mg/L were prepared respectively, the MOFs/MIPs catalysts (MOFs/MIPs-2) prepared in Example 2 were added respectively into the above-mentioned four solutions, the adding amount of the MOFs/MIPs catalyst prepared in Example 2 was 2.4 g/L (2.4 g of catalyst was input in solution per litre), in the 180 rpm table, an adsorption reaction was performed under the condition of constant temperature (25° C.), in 24 hours (it was ensured that absorption equilibrium was reached), the oxidizing agent PS (persulfate) was respectively added into the four solutions, and molar ratios of the adding amounts of the oxidizing agent PS to the adding amounts of the pollutants (DMP, DEP, DBP and DEHP) were 600:1; sampling and analyzing were performed at fixed points.

The degradation conditions of the four solutions are as shown in FIG. 3. FIG. 3 is a targeted degradation curved graph of the MOFs/MIPs to DMP and structural analogues thereof. A result of FIG. 3 shows that all the pollutants (DMP, DEP, DBP and DEHP) are quickly oxidized and degraded within the first hour (the degradation ratios of DMP, DEP, DBP and DEHP are respectively 90.0%, 66.5%, 57.6% and 58.8%), and then the degradation rate is slowed down. It illustrates that the MOFs/MIPs catalyst provided by the present invention and structural analogues thereof play removal roles, but are the best in targeted degradation effect on the template molecules DMP, which means that the MOFs/MIPs catalyst has good specific selectivity to the targeted pollutants and degrades the pollutants in a targeted manner.

The catalyst provided by the present invention is high in degrading efficiency, and can realize highly preferential adsorption and catalytic degradation of organic pollutants, so that it is good in stability. The catalyst provided by the present invention is a bulky catalyst, can avoid problems of difficulty in recovering a conventional water treatment catalyst and the like, and is easily applied accurately.

The above embodiments are merely preferred embodiments of the present invention and are merely used for explaining the present invention rather than limiting the present invention. Variations, substitutions and modifications made by those skilled in the field shall fall within the scope of protection of the present invention without departing from the spirit of the present invention.

1. An in-situ growth preparation method of a MOFs/MIPs catalyst, comprising the following preparation steps:
step (1) uniformly mixing template molecules, a functional monomer and a pore-foaming agent, performing a uniform ultrasonic dispersion, and performing a prepolymerization reaction to obtain a prepolymerization reaction product;
step (2) uniformly mixing a crosslinking agent and an initiator with the prepolymerization reaction product in the step (1) to obtain a mixed solution, then performing a water bath heating to conduct a polymerization reaction to obtain a reaction product after the water bath heating, eluting the template molecules by Soxhlet extraction, and performing a drying to obtain an imprinted polymer; and
step (3) uniformly mixing dimethyl formamide, 2,5-dyhydroxy terephthalic acid, ferrous chloride, water, methanol and the imprinted polymer in the step (2), performing a uniform ultrasonic dispersion, performing a heating treatment and a washing, then performing an immersion in methanol, performing a centrifugation to take a precipitate, washing and drying the precipitate to obtain the MOFs/MIPs catalyst.

2. The in-situ growth preparation method of an MOFs/MIPs catalyst according to claim 1, wherein the template molecules in the step (1) are dimethyl phthalate, the functional monomer is methacrylic acid, a volume ratio of the template molecules to the functional monomer is 2:1 to 4:1, the pore-forming agent is acetonitrile, a volume ratio of the template molecules to the pore-forming agent is 1:120 to 1:130, a time of the prepolymerization reaction ranges from 0.5 hour to 1.5 hours, and a temperature of the prepolymerization reaction ranges from 3° C. to 5° C.

3. The in-situ growth preparation method of an MOFs/MIPs catalyst according to claim 1, wherein the crosslinking agent in the step (2) is ethylene glycol dimethacrylate, a volume ratio of the crosslinking agent in the step (2) to the template modulates in the step (1) is 1:34 to 1:36, the initiator in the step (2) is azobisisobutyronitrile, and a mass volume ratio of the initiator in the step (2) to the pore-forming agent in the step (1) is (0.05-0.15): 1 g/mL.

4. The in-situ growth preparation method of an MOFs/MIPs catalyst according to claim 1, wherein a temperature of the water bath heating in the step (2) ranges from 55° C. to 65° C., and a time for the water bath heating ranges from 23 hours to 25 hours.

5. The in-situ growth preparation method of an MOFs/MIPs catalyst according to claim 1, wherein in the step (2), the reaction product after the water bath heating is subjected to Soxhlet extraction by using a mixed solution of methanol and acetic acid, so that the template molecules on the reaction product after the water bath heating are eluted, and specific recognition sites of the template molecules on the reaction product after the water bath heating are vacated, wherein a volume ratio of methanol to acetic acid is 8:1 to 10:1.

6. The in-situ growth preparation method of an MOFs/MIPs catalyst according to claim 1, wherein in the step (3), a volume ratio of 2,5-dyhydroxy terephthalic acid to dimethyl formamide is 1:175 to 1:185 g/mL, a mass volume ratio of ferrous chloride to dimethyl formamide is 1:87.5 to 1:92.5 g/mL, a volume ratio of dimethyl formamide to water is 17:1 to 19:1, a volume ratio of the dimethyl formamide to methanol is 17:1 to 19:1, and a mass volume ratio of the imprinted polymer to dimethyl formamide is 1:8 to 1:9 g/mL.

7. The in-situ growth preparation method of an MOFs/MIPs catalyst according to claim 1, wherein in the step (3), a temperature of the heating treatment ranges from 110° C. to 120° C., and a time for the heating treatment ranges from 23 hours to 25 hours.

8. The in-situ growth preparation method of an MOFs/MIPs catalyst according to claim 1, wherein in the step (3), the washing is washing with dimethyl formamide, and a time of the immersion in methanol ranges from 1 hour to 3 hours.

9. An MOFs/MIPs catalyst, prepared by the in-situ growth preparation method according to claim 1.

10. An application of the MOFs/MIPs catalyst according to claim 9 in degrading DMP in wastewater through targeted oxidation.
